(19) United States
(12) Patent Application Publication
(10) Pub. No.: US 2009/0119140 A1
(43) Pub. Date: May 7, 2009

(54) Process-controlled enterprise resource planning system (PERP)

(75) Inventors: Jyh-Huei Kuo, Taipei City (TW); Yuan-Chun Francis Li, Taipei City (TW)

Correspondence Address: BACON & THOMAS, PLLC, 625 SLATERS LANE, FOURTH FLOOR, ALEXANDRIA, VA, 22314-1176, US

(73) Assignee: TOPCO SCIENTIFIC CO., LTD, Taipei City (TW)

(21) Appl. No.: 12/149,699

(22) Filed: May 7, 2008

(30) Foreign Application Priority Data
Nov. 1, 2007 (TW) 096141254

(51) Int. Cl. G06Q 10/00

(52) U.S. Cl. 705/7

(57) ABSTRACT

The present invention discloses a process-controlled enterprise resource planning system (herein referred to as a PERP) that features an operational interface allows an operator to operate a required process in at least one start process interface or a start enterprise resource management interface. If the operator selects the start process interface, a process processing unit controls successive operational actions required the operator to operate the operational interface according to an event control process or the process-step control information corresponding to the start process interface. If the operator selects the enterprise resource management interface, an enterprise resource management processing unit controls management and process of the enterprise resource database according to the process-step control information corresponding to the start enterprise resource management interface. Thereupon, operational mistakes can be prevented and time-consumption for training the operator can be reduced.

### BACKGROUND OF THE INVENTION

1. Technical Field

The present invention relates to an enterprise resource planning system (ERP) via process-controlled and, more particularly, to a technical field that utilizes implement step of gradual progress to manage enterprise resource planning based on the event process control or processing control information.

2. Description of Related Art

In the attempt to cope with various enterprise resources and complex enterprise factors, enterprise resource planning (ERP) systems are generally adopted by enterprises to enhance resource control abilities of the enterprises. Such ERP systems help enterprise owners to identify the current situation and historical data of the enterprises and thereby the enterprise owners can make optimum strategic decisions on future resource management. However, though such ERP systems or other management systems for enterprises are referred to process concepts, no any trace of the process concepts can be found in the designs and presentation of the systems. Thus, only people who have particular experiences can swimmingly operate such conventional systems. For example, in a human resource department of an enterprise, a staffer has to be properly trained so as to master the complex procedures for filling forms, filing, re-filing, approval, severance pay issuing, or invaliding access cards. A novice or a first-time operator may need to spend a lot of time on training to know the operation of the processes, and incorrect data may be liable to occur due to the operator's unfamiliarity with the system. Therefore, it is an issue of making a first-time operator to master the operational steps of the system promptly.

In view of the aforementioned problems of the prior arts, the inventor of the present invention, with the practical experience for years thereof, has developed an enterprise resource planning (ERP) system with processes control so that various EPR operations are segregated and combined with process management in order to remedy the above defects of the prior art.

### SUMMARY OF THE INVENTION

It is one objective of the present invention to provide a process-controlled enterprise resource planning system (herein referred to as a PERP) to overcome the problems about labor and time consumption for operating relevant processes, data inconsistency or data faults resulted from careless implement steps, poor inter-organizational collaboration, such that enterprises may encounter while managing resources thereof.

To achieve the above objective, the PERP (process-controlled enterprise resource planning system) of the present invention comprises an operational interface, a process processing unit, an enterprise resource management processing unit, a process database and an enterprise resource database.

The operational interface provides at least a start-process interface alone or in company with a start enterprise resource management interface to an operator. The process processing unit controls successive operational actions required for the operator operates the operational interface and links related and different operational processes according to event control process or the process-step control information corresponding to the start-process interface. The enterprise resource management processing unit controls the management and processing of the enterprise resource database according to the process-step control information corresponding to the start enterprise resource management interface.

The process database contains a plurality of preset event control processes or the process-step control information when the start process interface corresponds to at least one event control process or the process-step control information. The enterprise recourse database contains a plurality of the process-step control information and records of database processing of related enterprise resources that carry information of the related enterprise resources.

### BRIEF DESCRIPTION OF THE DRAWINGS

The invention as well as a preferred mode of use, further objectives and advantages thereof, will best be understood by reference to the following detailed description of an illustrative embodiment when read in conjunction with the accompanying drawings, wherein:

FIG. 1 is a block diagram of the process-controlled enterprise resource planning system of the present invention;

FIGS. 2A to 2D are exemplificative screens according to some preferred embodiments of the process-controlled enterprise resource planning system of the present invention; and

FIG. 3 is a flow chart of the process-controlled enterprise resource planning method of the present invention.

### DETAILED DESCRIPTION OF THE PREFERRED EMBODIMENT

In the following description of the preferred embodiments of the present invention referred to the accompanying drawings, same components will be marked with same notations for easy understanding.

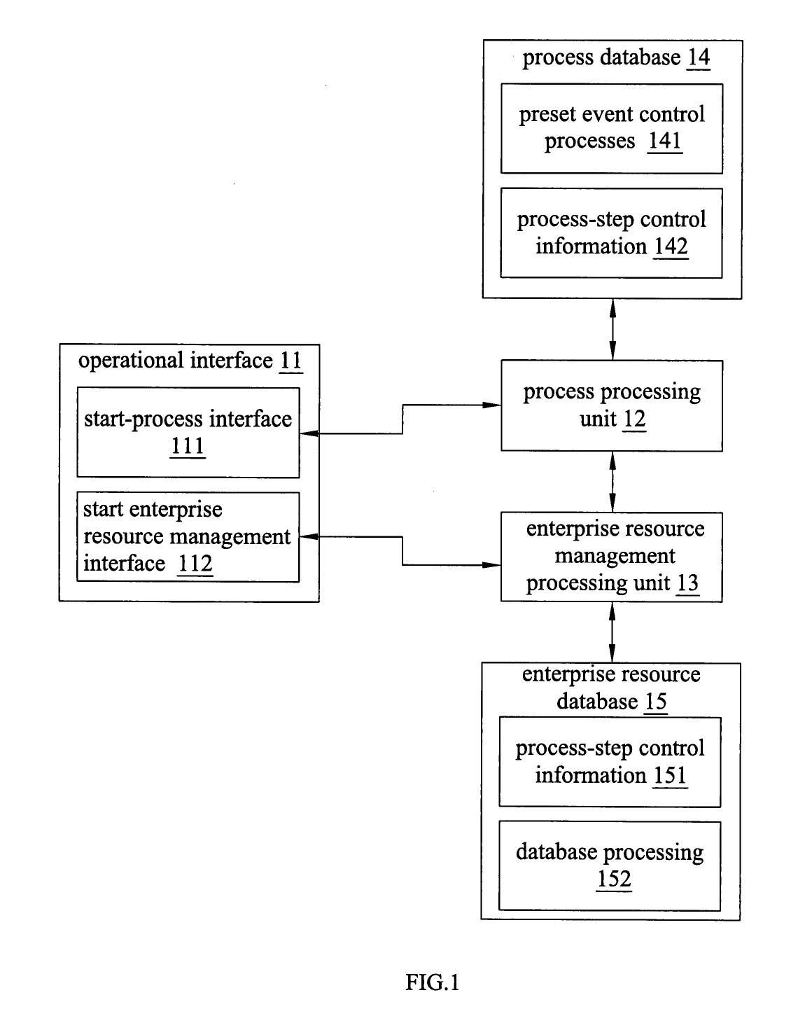

Please refer to FIG. 1 for the block diagram of the process-controlled enterprise resource planning system of the present invention. Therein, the disclosed system comprises an operational interface 11, a process processing unit 12, an enterprise resource management processing unit 13, a process database 14 and an enterprise resource database 15.

The operational interface 11 provides at least a start-process interface 111 alone or in company with a start enterprise resource management interface 112 to an operator. The process database 14 contains a plurality of preset event control processes 141 or process-step control information 142 while the start-process interface 111 corresponds to at least one event control process 141 or process-step control information 142. When the operator operates the start-process interface 111 for tasks such as human resource management, stock management, production management, selling management or financial management, the process processing unit 12, according to the event control process 141 or the process-step control information 142 corresponding to the start-process interface 111, controls successive operational actions required for the operator to operate the operational interface 11. Alternatively, when the operator operates the start-process interface 111, tasks of the start enterprise resource management interface 112, such as the operation of proposing a purchasing invoice, can also be launched. Hence, the process processing unit 12 in the process can link the related enterprise resource management processing unit 13 in responding to diverse operations and demands.

The enterprise resource database 15 contains a plurality of process-step control information 151 and records of database processing 152 of related enterprise resources that carry information of the related enterprise resources. When the operator operates the start enterprise resource management interface 112, the enterprise resource management processing unit 13 controls the management and processing for the enterprise resource database 15 based on the process-step control information 151 corresponding to the start enterprise resource management interface 112. Thereby, the operator can be aware of successive operational steps required by the system and implement enterprise resource management properly, thereby avoiding operational mistakes and reducing time consumption of training the operator.

Therein, the operational interface 11 is preferably one of a keyboard, a touch panel and a mouse, and adopts a web-based design. The process processing unit 12 and the enterprise resource management processing unit 13 are preferably microprocessors. The process database 14 and the enterprise resource database 15 can be stored in a hard drive device (HDD), a flash memory or a storage memory.

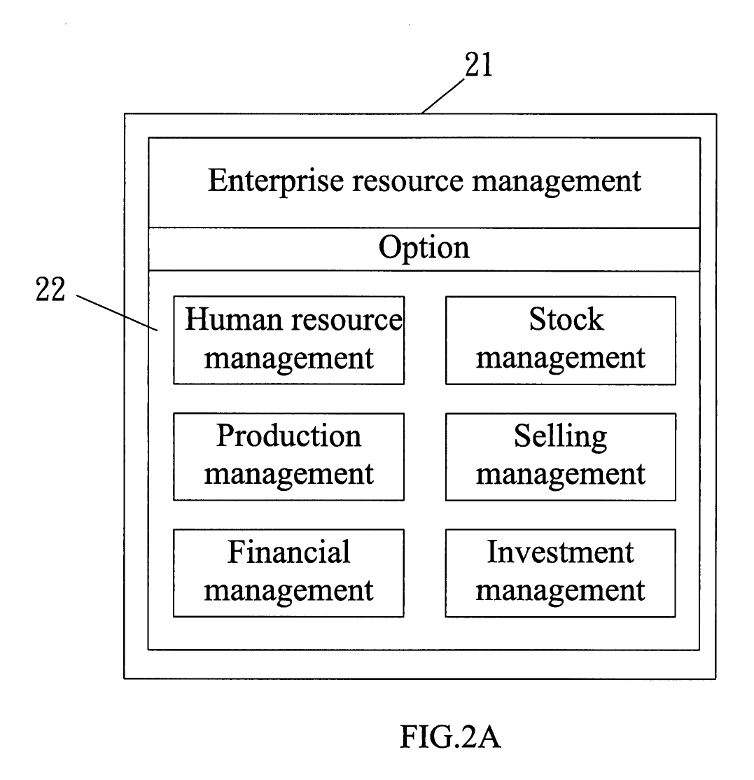

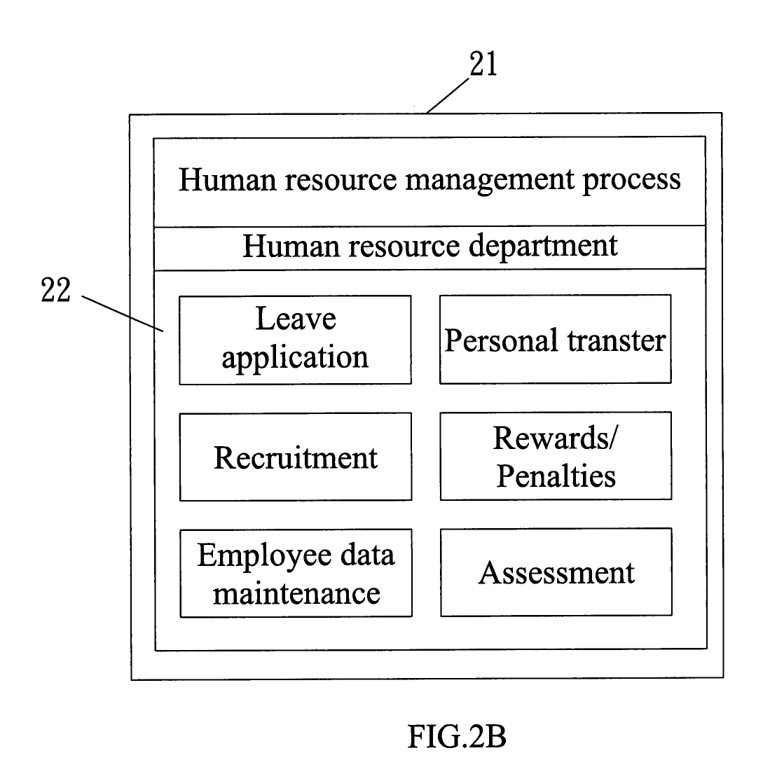

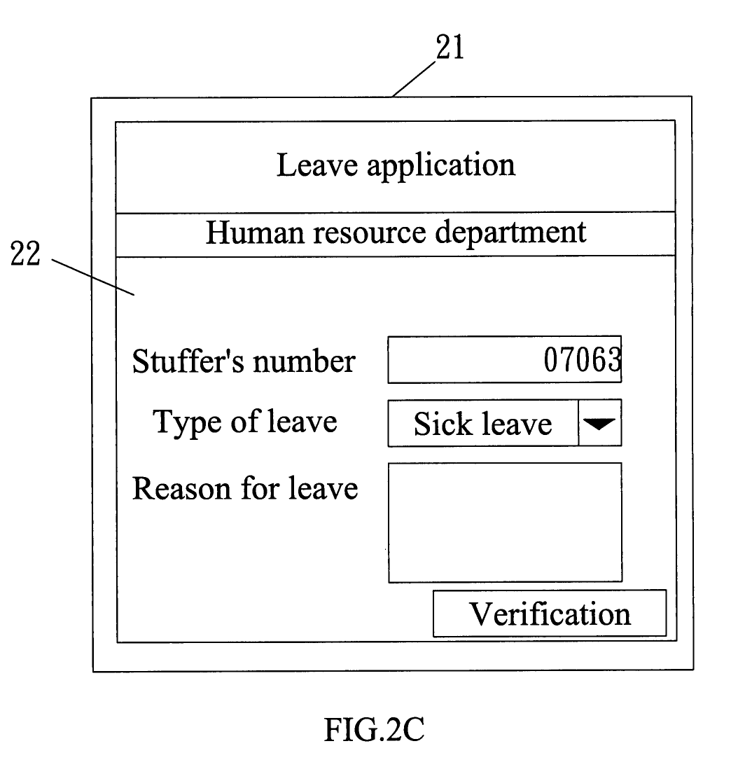

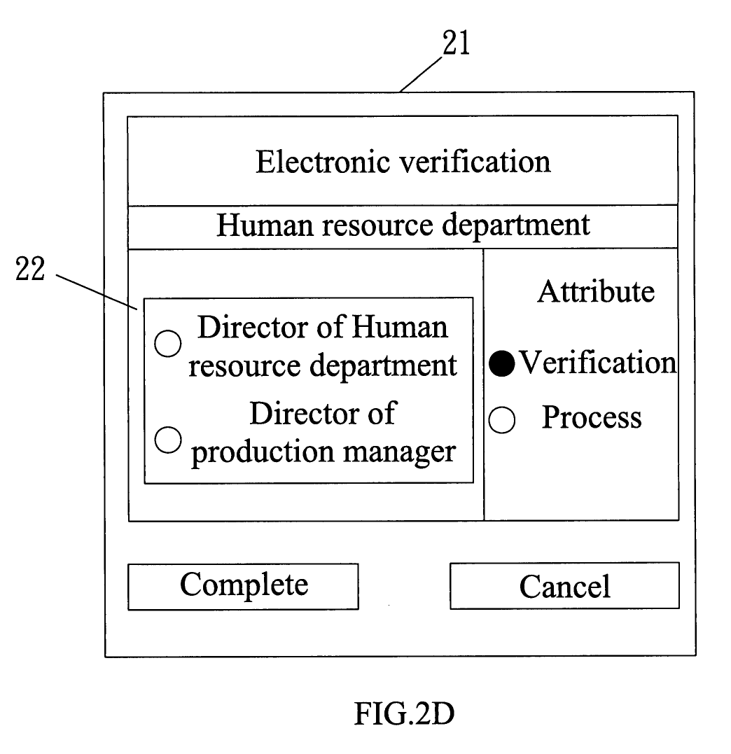

Please refer to FIGS. 2A to 2D for exemplificative screens according to some preferred embodiments of the process-controlled enterprise resource planning system (ERP) of the present invention, which are related to an operational process presented when the operator operates the start-process interface 111. In FIG. 2A, when the operator enters an enterprise resource management function through the process-controlled EPR system, the process processing unit 12 extracts related options corresponding to the enterprise resource management from the process database 14 so that the operator can select a start screen 22 showing an enterprise resource management process, such as human resource management, stock management, production management, selling management or financial management, from options related to enterprise resource management that are presented in a display device 21. The process database 14 contains a plurality of preset event control processes 141 or process-step control information 142 while the start process 22 of the enterprise resource management process corresponds to at least one event control process 141 or process-step control information 142. The process database 14 may be stored in a hard drive device (HDD), a flash memory or a storage memory.

If the operator selects the start process 22 of “human resource management”, the process processing unit 12 implements the preset event control process 141 or process-step control information 142 according to the selected start process 22 and presents the relevant preset event control process 141 or process-step control information 142 on the display device 21. Afterward, in FIG. 2B, if the operator selects the process of “leave application”, the process processing unit 12 implements the preset event control process 141 or process-step control information 142 and progressively presents the operational steps on the display device 21. In FIG. 2C, the process processing unit 12 starts the related enterprise resource management processing unit 13 to lead the operator to enter the related enterprise resource management interface. After entering the process-step control information 151 and database processing 152 of the enterprise resource database 15, the operator can gradually fill in the fields of staffer's number, name, type of leave (e.g. sick leave, personal leave, official leave, etc.) and the reason for leave. The operator can click a start button to synchronously update the related data in the enterprise resource database 15. If more than one task needs to be implemented, all the related undertakers can be notified through the controlled-process. For example, in a resignation operation, in addition to maintaining human resource data undertaken by the human resource department, safety operation management and financial operation can also be conducted sequentially. All these operations are simultaneously forwarded to the process processing unit 12 to conduct the preset event control process 141 or the process-step control information 142 and present relevant options of the event control process 141 or the process-step control information 142 on the display devices 21 of the relevant undertakers.

In FIG. 2D, after the start button is pressed, the approval of the relevant appointed staff is presented. After the completion button is pressed, the system can directly deliver this electronic approval forms to the directors of the human resource department and the production department, and synchronously update the related data in the enterprise resource database 15. Thereby, even one who has never operated this system before can easily follow the progressive operational steps to accomplish the processing process of the electronic approval and enterprise resource information. Meantime, other processes in the enterprise can be operated in the same manner to reduce labors and time consumption for training a novice and help the novice to promptly master the operational process. Besides the operator's work efficiency, such as processing time for tasks to be fulfilled, can be assessed accordingly.

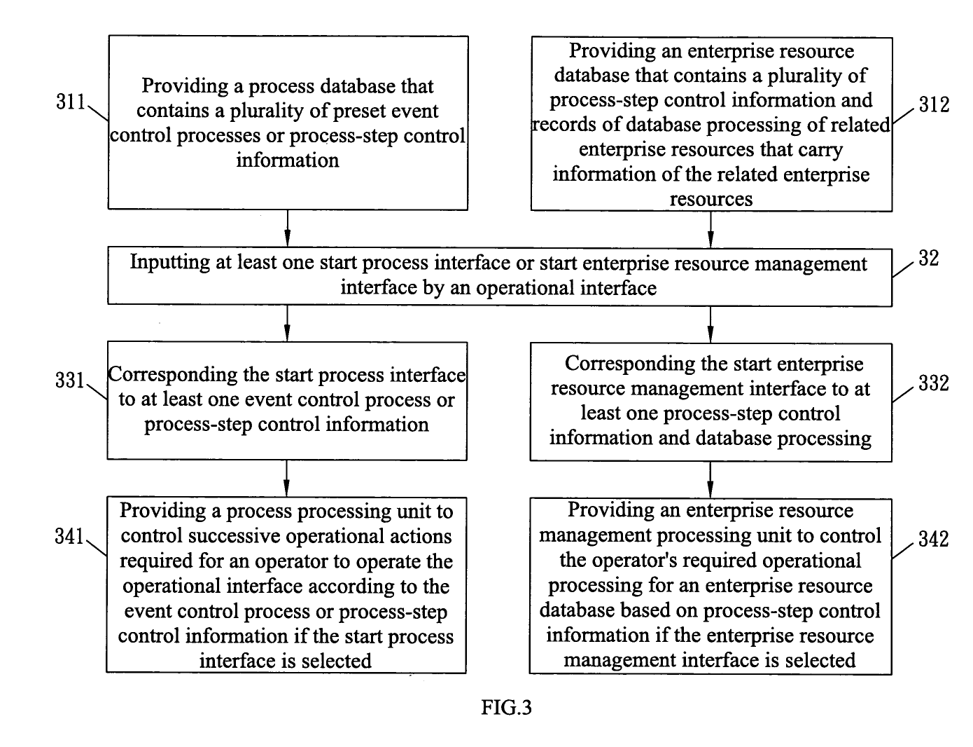

Now please refer to FIG. 3 for a flow chart of the process-controlled enterprise resource planning method of the present invention. Therein, the method comprises the following steps:

Step 311: Providing a process database that contains a plurality of preset event control processes or process-step control information;

Step 312: Providing an enterprise resource database that contains a plurality of process-step control information and records of database processing of related enterprise resources that carry information of the related enterprise resources;

Step 32: Inputting at least one start process interface or start enterprise resource management interface by an operational interface;

Step 331: Corresponding the start process interface to at least one event control process or process-step control information;

Step 332: Corresponding the start enterprise resource management interface to at least one process-step control information and database processing;

Step 341: Providing a process processing unit to control successive operational actions required for an operator to operate the operational interface according to the event control process or process-step control information if the start process interface is selected; and

Step 342: Providing an enterprise resource management processing unit to control the operator's required operational processing for an enterprise resource database based on process-step control information if the enterprise resource management interface is selected.

Although the particular embodiments of the invention have been described in detail for purposes of illustration, it will be understood by one of ordinary skill in the art that numerous variations will be possible to the disclosed embodiments without going outside the scope of the invention as disclosed in the claims.

What is claimed is:

1. A process-controlled enterprise resource planning system, comprising
an operational interface for providing at least a start process interface or a start enterprise resource management interface to an operator;
a process processing unit for controlling successive operational actions required for the operator to operate the operational interface according to an event control process or a process-step control information corresponding to the start process interface;
an enterprise resource database for containing a plurality of process-step control information and records of database processing of related enterprise resources that carry information of the related enterprise resources;
an enterprise resource management processing unit for controlling management and processing of the enterprise resource database according to the process-step control information corresponding to the start enterprise resource management interface; and
a process database for containing a plurality of preset event control processes or process-step control information, wherein the starting process interface corresponds to at least one event control process or the process-step control information.

2. The system of claim 1, wherein the operational interface is selected from one of a keyboard, a touch panel and a mouse.

3. The system of claim 1, wherein the operational interface is adopted with of a web-based design.

4. The system of claim 1, wherein the process processing unit is a microprocessor.

5. The system of claim 1, wherein the enterprise resource management processing unit is a microprocessor.

6. The system of claim 1, wherein the process database is stored in one of a hard drive device (HDD), a flash memory or a storage memory.

7. The system of claim 1, wherein the enterprise resource database is stored in one of a hard drive device (HDD), a flash memory or a storage memory.

8. A process-controlled enterprise resource planning method, comprising:
providing a process database that contains a plurality of preset event control processes or process-step control information;
inputting at least a start process interface or a start enterprise resource management interface by an operational interface, wherein the start process interface corresponds to at least one event control process or process-step control information and the starting enterprise resource management interface corresponds to the process-step control information and the database processing;
providing a process processing unit to control successive operational actions required for an operator to operate the operational interface according to the event control process or the process-step control information; and
providing an enterprise resource management processing unit to control required operator's operational processing of the enterprise resource database according to the process-step control information.
